(19) United States
(12) Patent Application Publication
(10) Pub. No.: US 2024/0079593 A1
(43) Pub. Date: Mar. 7, 2024

(54) SELF-CROSSLINKING COMPOSITE BINDERS FOR ELECTRODES

(71) Applicant: Washington State University, Pullman, WA (US)

(72) Inventors: Panpan Dong, Pullman, WA (US); Min-Kyu Song, Pullman, WA (US)

(21) Appl. No.: 18/235,950

(22) Filed: Aug. 21, 2023

Related U.S. Application Data
(60) Provisional application No. 63/399,962, filed on Aug. 22, 2022.
(60) Provisional application No. 63/484,396, filed on Feb. 10, 2023.

(51) Int. Cl. H01M 4/62; C08F 220/06; H01M 4/04; H01M 4/139

(52) U.S. Cl. CPC H01M 4/622; C08F 220/06; H01M 4/0404; H01M 4/0471; H01M 4/139; C08F 2810/00

(57) ABSTRACT

Compositions of self-crosslinking composite binders for silicon-based electrodes, associated processes of forming silicon-based electrodes using the composite binders, as well as batteries utilizing the silicon-based electrodes formed using the composite binders are disclosed herein. In certain examples, the composite binder can include a first component configured to provide structural integrity in a silicon-based electrode and a second component configured to form a mesh-like structural network with the first component to provide flexibility of the silicon-based electrode and adhesiveness toward a current collector. The flexible mesh-like structural network is formed via gradient hydrogen bonds between chains of the first component and chains of the second components.

### CROSS-REFERENCE TO RELATED APPLICATION(S)

This application claims priority to U.S. Provisional Application No. 63/399,962, filed on Aug. 22, 2022, and 63/484,396, filed on Feb. 10, 2023, the disclosures of which are incorporated herein by reference in its entirety.

### BACKGROUND

Lithium-ion batteries are a type of batteries in which lithium ions move from a negative electrode (i.e., anode) via an electrolyte to a positive electrode (i.e., cathode) during discharging and from the cathode to the anode during charging. Typically, the cathode includes an intercalated lithium compound while the anode includes a carbon-based compound, such as graphite. Compared to other types of batteries, lithium-ion batteries have a high energy-to-weight ratio, low or no memory hysteresis, and long charge-holding abilities when not in use. In addition to applications in consumer electronics, popularity of lithium-ion batteries is growing in defense, automotive, energy storage, and aerospace applications. Such new applications impose a continued need to improve energy density, cyclability, energy efficiency, and other performance metrics of lithium-ion batteries.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Typically, lithium-ion batteries use anodes containing conductive carbon-based materials, such as graphite. Graphite and other carbon-based materials, however, tend to limit charging capacities of lithium-ion batteries. For example, lithiation of a carbon-based anode can produce a charging capacity of about 372 mAh g⁻¹, while lithiation of silicon (Si) can produce a charging capacity of about 4,200 mAh g⁻¹. Though having a higher charging capacity than carbon, silicon anodes can have 300% volume change during lithiation. Thus, after a few charge-discharge cycles, bulk silicon-based anodes would be pulverized. Silicon in anodes can also form unstable solid-electrolyte interphase layers with the electrolyte in lithium batteries, resulting in increased internal resistances and low Coulombic efficiency during charge/discharge cycling. Thus, poor mechanical stability and chemical passivation properties of silicon can render silicon anodes unsuitable for practical battery systems.

One strategy to address the foregoing drawback of using silicon for anodes is forming nanostructured silicon such as nanosprings, nanotubes, nanowires, silicon-based nanocomposites, or porous silicon-based nanomaterials. Such nano-sized silicon materials can effectively mitigate the pulverization issue of silicon anodes. However, synthesizing such nanostructured silicon is typically expensive (e.g., via chemical vapor deposition) and thus not favorable in large-scale industrial production. As such, various micro-sized silicon anodes have been studied for practical applications. As used herein, “micro-sized” generally refers to having a dimension of between about 1 micrometer to about 1,000 micrometers or 1 millimeter. Electrodes with micro-sized silicon materials, however, still suffer from issues of particle pulverization due to large volume changes during charge/discharge cycling, and thus leading to capacity decay and limited cycle life of lithium-ion batteries.

Another strategy is to use binders to improve structural integrity of silicon-based anodes and thus enhance electrochemical performance. As such, a suitable binder can provide a robust bonding network inside electrodes to mitigate or accommodate large volume changes during charge/discharge cycling. A suitable binder can also facilitate good electrochemical stability during operation. Moreover, a suitable binder can exhibit sufficient adhesion toward a current collector (e.g., a copper foil or other suitable types of metal foil) to prevent detachment of electrode materials during charge/discharge cycling. However, conventional binders for graphite-based materials are typically unsuitable for silicon-based materials due to a lack of the foregoing properties. For instance, a poly(acrylic acid) (PAA) binder cannot tolerate large volume changes of silicon-based materials due to rigidness of PAA while others such as polyvinylidene fluoride and sodium carboxymethyl cellulose have weak adhesion with silicon and metals such as copper.

Several embodiments of the disclosed technology are directed to compositions of self-crosslinking composite binders for silicon-based electrodes, associated processes of forming silicon-based electrodes using the composite binders, as well as batteries utilizing the silicon-based electrodes formed using the composite binders. In certain embodiments, the composite binder can include a first component and a second component. In other embodiments, the composite binder can also include additional components, such as other polymers, polypeptides, or other suitable materials in addition to or in lieu of the first or second component.

In certain embodiments, the first component can be configured to provide structural integrity for forming an electrode, such as a silicon-based anode. For instance, the first component can include a polymer having the following formula:

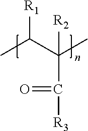

where each of R1, R2, and R3 includes hydrogen or —OX, wherein X is H, Li, Na, K, or a functional group having a formula of CₘH₂ₘ₊₁, m is an integer in the range from 1 to 10. In a particular example, the first component can include PAA having a molecular weight in a range from about 2,000 to about 300,000. In other embodiments, the first component can also include other materials to provide suitable target properties to the formed electrode.

The second component can be configured to crosslink with molecular chains of the first component to form a structural network that binds electrode materials such as micro-sized silicon particles. The second component can impart not only flexibility to the formed structural network but also adhesiveness toward a current collector, such as a metal foil. In certain embodiments, the second component can include polypeptide chains each having one or more amino acids with amide and hydroxyl groups that can crosslink with functional groups (e.g., carboxylic groups) of the first component via inter- and/or intra-chain gradient hydrogen bonds. As used herein, the term “gradient hydrogen bonds” generally refers to hydrogen bonds with different bonding energies. In one example, the second component can include silk fibroin (SF), which primarily contains polypeptide chains of glycine, serine, and alanine. In other examples, the second component can also include one or more of spider silk protein, wool keratin, soy protein, silk sericin, or other suitable amino acid materials.

By crosslinking, via the gradient hydrogen bonds, with molecular chains of the first component, the second component can form a structural network (e.g., a “mesh”) with the first component that binds the electrode materials. For example, the mesh can include molecular chains of the first component extending along a first direction and polypeptide chains of the second component crosslinking the molecular chains of the first component along a second direction via gradient hydrogen bonds. It is believed that the gradient hydrogen bonds can impart certain levels of rigidity/flexibility to the mesh, and this property can be adjusted by, for instance, varying the weight percentage, the concentration, or the mass ratio of the first or second component. Example ranges for the weight percentage of the first or second component can be from about 1 wt % to about 20 wt %. Example ranges for the concentration of the first or second component can be from about 5 wt % to about 40 wt %. Example ranges of the mass ratio of the first and second component can be from about 1 to about 0.01.

As discussed in more detail herein, adjusting the rigidity/flexibility of the formed structural network of the first and second components can result in controllable glass transition temperatures, suitable adhesive strengths, and improved electrochemical stability of micro-sized silicon anodes. For instance, experiments were conducted using an example binary composite binder of PAA and SF for forming micro-sized silicon/carbon (Si/C) anodes. The process of forming the Si/C anodes includes mixing PAA with SF in a solvent to derive a slurry, coating a metal foil with the derived slurry, and drying the metal foil coated with the slurry under vacuum.

Density-functional theory calculations revealed that the composite binder of PAA/SF showed gradient bonding inside the Si/C anodes via intra-chain gradient hydrogen bonds ranging from −14.28 to −19.04 kcal mol⁻¹. During experiments, a mass ratio of PAA to SF was adjusted to produce Si/C anodes with both target structural integrity and flexibility to accommodate large volume changes during charge/discharge cycling. The mass ratio of PAA to SF in the composite binder can also be adjusted to achieve a strong adhesion force (275 N m⁻¹) of the Si/C anodes towards a current collector (e.g., a copper foil), and thus maintaining structural integrity of the Si/C anodes during charge/discharge cycling. Based on such characteristics, the formed Si/C anodes with the example composite binder of PAA/SF exhibited enhanced rate capability and cyclability (up to 500 cycles at 0.5 C) over silicon-based anodes formed using other studied binders.

### BRIEF DESCRIPTION OF THE DRAWINGS

FIGS. 1A and 1B are schematic diagrams showing an example battery incorporating an anode formed using a composite binder configured in accordance with embodiments of the disclosed technology.

FIG. 2 shows example chemical interactions between PAA and SF in an example anode suitable for the battery in FIGS. 1A and 1B in accordance with embodiments of the disclosed technology.

FIGS. 3A-3D are example schematic diagrams showing micro-sized silicon particles with —OH groups, hydrogen bonds between PAA and SF, lithiation/delithiation process of PAA-based silicon-based electrode, and lithiation/delithiation process of PAA/SF silicon-based electrode, respectively, in accordance with embodiments of the disclosed technology.

FIGS. 4A-4F show digital photos of example binders composed of PAA, PAA/SF (4/1), PAA/SF (2/1), PAA/SF (1/1), PAA/SF (1/2), and SF, respectively, after mixing in accordance with embodiments of the disclosed technology.

FIGS. 5A-5F show digital photos of example binders composed of PAA, PAA/SF (4/1), PAA/SF (2/1), PAA/SF (1/1), PAA/SF (1/2), and SF, respectively, of FIGS. 4A-4F after rest one week at 23° C. in accordance with embodiments of the disclosed technology.

FIGS. 6A and 6B show Fourier-transform infrared spectra (FTIR) plot of example binder solutions in FIGS. 4A-4F dried at 155° C. for 2 hours under vacuum in accordance with embodiments of the disclosed technology.

FIG. 7 shows differential scanning calorimetry (DSC) results of example binder solutions in FIGS. 4A-4F dried at 155° C. for 2 hours under vacuum in accordance with embodiments of the disclosed technology.

FIG. 8 shows X-ray diffraction (XRD) results of example Si/C particles and Si/C electrodes using different example binders in accordance with embodiments of the disclosed technology.

FIGS. 9A-9F show scanning electron microscope (SEM) images of surfaces of example silicon/carbon electrodes using PAA, PAA/SF (4/1), PAA/SF (2/1), PAA/SF (1/1), PAA/SF (1/2), and SF, respectively, in accordance with embodiments of the disclosed technology.

FIGS. 10A-10F show SEM images of cross-sections of example silicon/carbon electrodes using PAA, PAA/SF (4/1), PAA/SF (2/1), PAA/SF (1/1), PAA/SF (1/2), and SF, respectively, in accordance with embodiments of the disclosed technology.

FIG. 11 shows digital photos of example Si/C electrodes formed using example binders after 180-degree peeling test in accordance with embodiments of the disclosed technology.

FIG. 12 shows adhesive force per width-displacement curves of Si/C electrodes formed with different example binders on copper foil in accordance with embodiments of the disclosed technology. The displacement rate was 60 mm min⁻¹ during a 180-degree peeling test.

FIGS. 13A-13F show example cycling performance of example Si/C electrodes with PAA and PAA/SF composite binders at 0.5 C at various cycling levels in accordance with embodiments of the disclosed technology.

FIGS. 14A-14F shows CV curves of PAA/SF-based Si/C electrode at a scan rate of 0.1 mV s⁻¹; rate capability of PAA- and PAA/SF-based Si/C electrodes at 0.2 C, 0.3 C, 0.5 C, 1.0 C, and back to 0.2 C; voltage profiles of PAA-based and PAA/SF-based Si/C electrode under various C-rates; Nyquist plots of PAA- and PAA/SF-based electrode after rate capability measurement; and cycling performance of PAA/SF-based Si/C electrode under 1.0 C at a constant discharge capacity of 1000 mAh g⁻¹ in accordance with embodiments of the disclosed technology.

### DETAILED DESCRIPTION

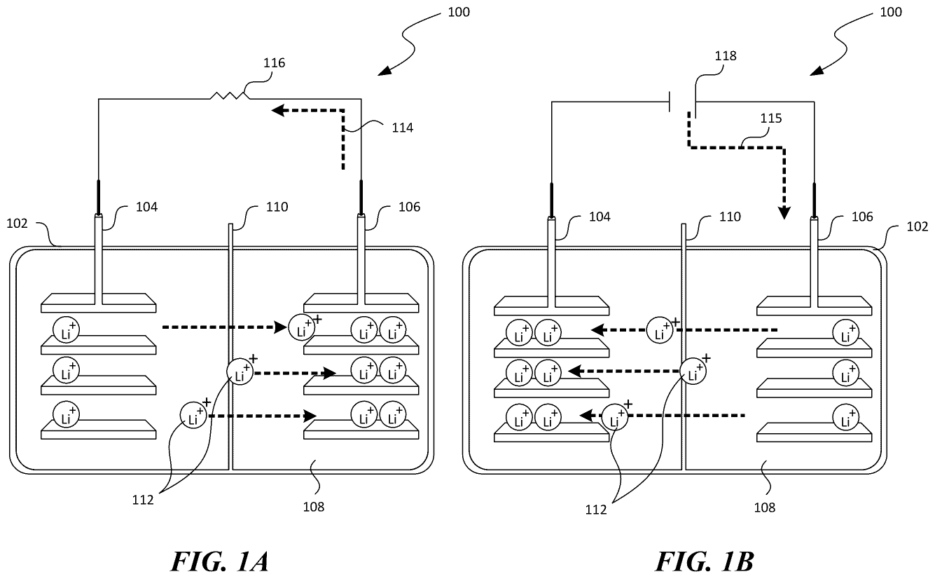

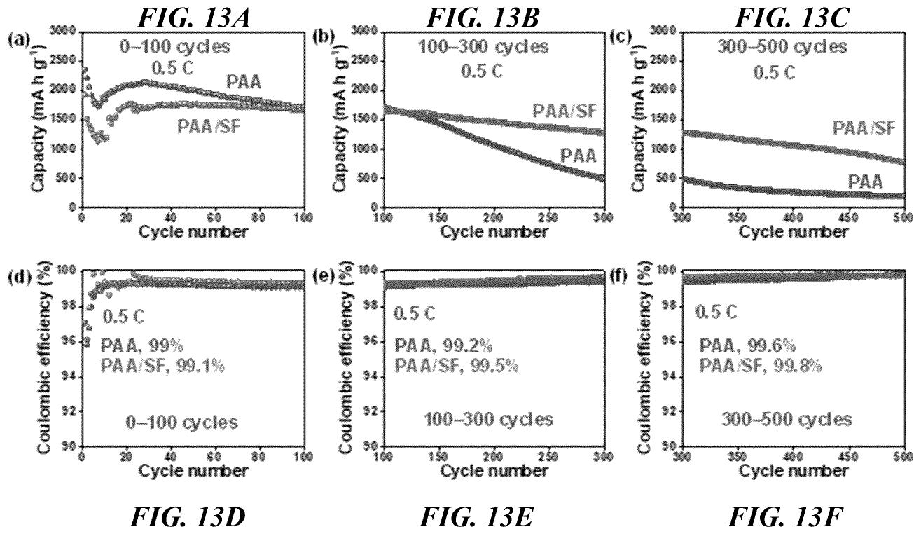

Various embodiments of battery systems, devices, and associated methods of making are described herein. Even though the technology is described below using a lithium-ion battery as an example, in other embodiments, the technology may be applicable in other suitable types of batteries (e.g., batteries containing sodium, potassium, calcium, magnesium, cadmium, selenium, or copper ions), a chemical sensor, a gas separation membrane, an organic thin film transistor, an electromechanical actuator, a fuel cell, and/or other suitable electronic components. In addition, certain embodiments of the self-crosslinking composite binders described herein may also be used to bind carbon, metals, or other suitable types of particles for any suitable applications. In the following description, specific details of examples are included to provide a thorough understanding of certain embodiments of the disclosed technology. A person skilled in the relevant art will also understand that the disclosed technology may have additional embodiments or may be practiced without several of the details of the embodiments described below with reference to FIGS. 1A-14F.

Lithium-ion batteries typically use carbon-based materials, such as graphite, as anodes. However, carbon-based materials tend to limit charging capacities of lithium-ion batteries. For example, lithiation of a carbon-based anode can produce a charging capacity of about 372 mAh g⁻¹ while lithiation of silicon (Si) can produce a charging capacity of about 4,200 mAh g⁻¹. However, lithiation in silicon can involve about 300% volume change. Thus, after a few charge-discharge cycles, a bulk silicon-based anode would be pulverized. Silicon anodes can also form unstable solid-electrolyte interphase layers with electrolytes in lithium-ion batteries. As such, the poor mechanical stability and chemical passivation properties of silicon can render silicon electrodes unsuitable for practical battery systems.

Several embodiments of the disclosed technology are directed to compositions of self-crosslinking composite binders for silicon-based electrodes, associated processes of forming silicon-based electrodes using the composite binders, as well as batteries utilizing the silicon-based electrodes formed using the composite binders. In certain embodiments, the composite binder can include a first component configured to provide structural integrity to a silicon-based electrode and a second component configured to form a flexible structural network with the first component to provide flexibility of the silicon-based electrode and adhesiveness toward a current collector. In one example, the first component can include PAA while the second component can include SF. It is believed that the flexible structural network can lead to controllable glass transition temperatures, high adhesive strengths, and good electrochemical stability of micro-sized silicon anodes formed using the composite binder, as discussed in more detail below.

FIG. 1A is a schematic diagram of an example lithium-ion battery 100 during discharging, and FIG. 1B is a schematic diagram of the lithium-ion battery 100 during charging in accordance with embodiments of the technology. As shown in FIGS. 1A and 1B, the lithium-ion battery 100 can include a container 102 holding an anode 104, a cathode 106, an electrolyte 108, and an optional membrane 110 in the electrolyte 108. Even though only certain components are shown in FIGS. 1A and 1B, in other embodiments, the lithium-ion battery 100 can also include insulators, gaskets, vent holes, and/or other suitable components (not shown). In further embodiments, the membrane 110 may be omitted.

The cathode 106 can be constructed from a layered oxide (e.g., lithium cobalt oxide (LiCoO₂)), a polyanion (e.g., lithium iron phosphate (LiFePO₄)), or a spinel (e.g., lithium manganese oxide (LiMn₂O₄)). Other suitable materials for the cathode 106 can include lithium nickel oxide (LiNiO₂), lithium iron phosphate fluoride (Li₂FePO₄F), lithium cobalt nickel manganese oxide (LiCo_{1/3}Ni_{1/3}Mn_{1/3}O₂), Li(LiₐNiₓMn_{y}Co_{z})O₂, and/or other suitable cathode materials (e.g., sulfur, selenium, selenium sulfide, oxygen, or carbon dioxide). Additional examples of metal compositions suitable for the cathode 106 can also include:
LiNiCoAlO₂ having 80% Nickel, 15% Cobalt, and 5% Aluminum
LiCoO₂ having 100% Cobalt
LiMn₂O₄ having 100% Manganese
LiNiMnCoO₂ having 33.3% Nickel, 33.3% Manganese, and 33.3% Cobalt
LiFePO₄ having 100% Iron

In certain embodiments, the electrolyte 108 can include a non-aqueous solution of organic carbonates such as ethylene carbonate or diethyl carbonate containing complexes of lithium ions. The electrolyte 108 can contain non-coordinating anion salts such as LiPF₆, LiAsF₆, LiClO₄, LiBF₄, and lithium triflate. In other embodiments, the electrolyte 108 may also include an aqueous and/or a partially aqueous solution of lithium salts and/or other suitable compositions (e.g., quasi-solid or solid electrolytes).

As shown in FIG. 1A, during discharging, lithium ions 112 are extracted from the anode 104 (commonly referred to as delithiation) and migrate toward the cathode 106 via the electrolyte 108. The lithium ions 112 pass through the optional membrane 110 and are inserted into the cathode 106. As a result, a current 114 flows from the cathode 106 past a load 116 to the anode 104. As shown in FIG. 1B, during charging, a charger 118 provides a charging current 115 to the cathode 106. The charging current 115 causes lithium ions 112 to be extracted from the cathode 106 and move toward the anode 104. The lithium ions 112 pass through the optional membrane 110 and are then inserted into the anode 104 via, e.g., alloying and/or otherwise combining with the material of the anode 104, commonly referred to as lithiation.

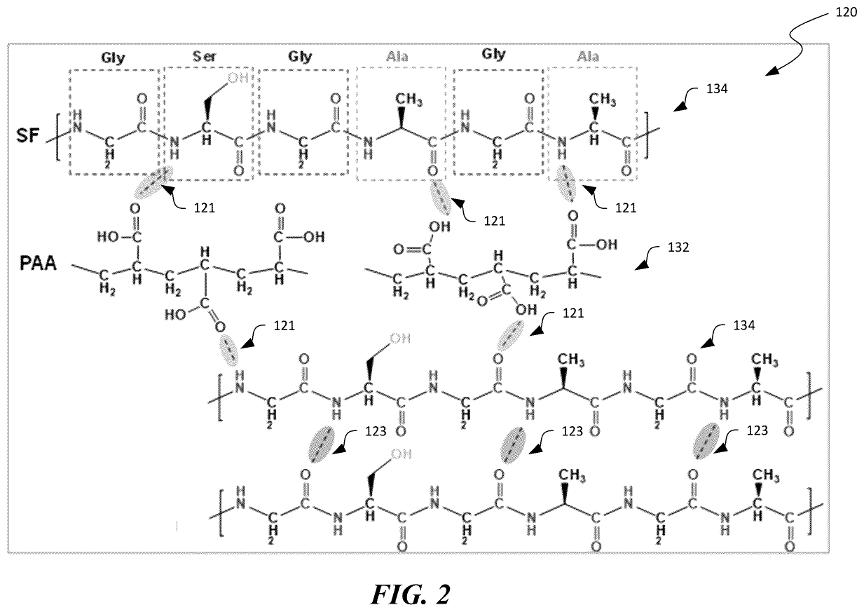

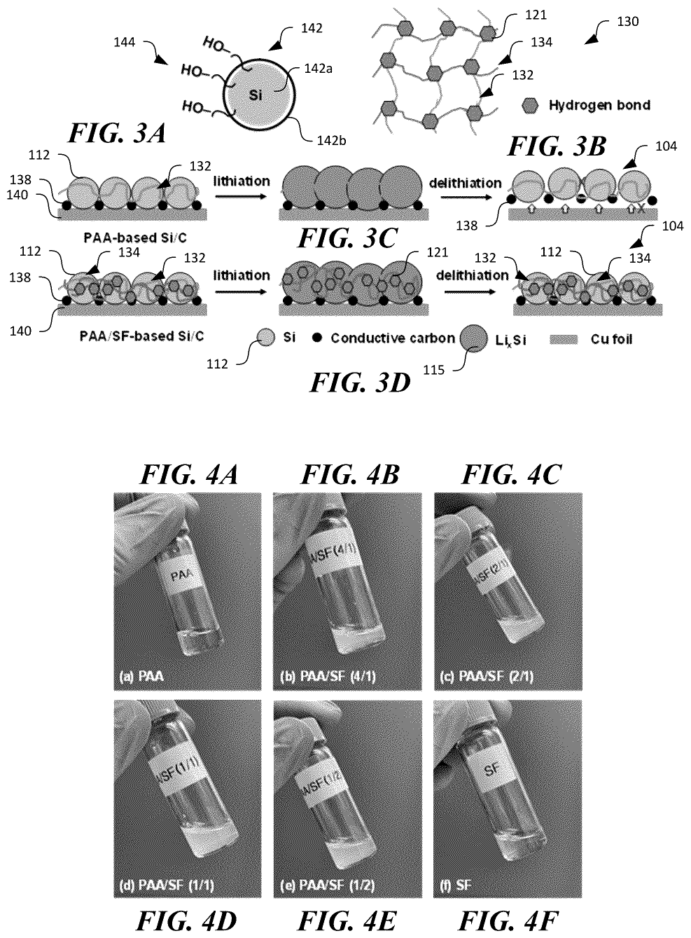

Such lithiation/delithiation at the anode 104 can involve about 300% volume changes when the anode 104 contains bulk or micro-sized silicon. In accordance with several embodiments of the disclosed technology, the anode 104 can be constructed, at least partially, from a self-crosslinking composite binder 120 (shown in FIG. 2) and micro-sized silicon particles 112 (shown in FIG. 3A) to accommodate such large volume changes, and thus improve cyclability of the lithium-ion battery 100. For instance, the composite binder 120 can include a first component configured to provide structural integrity to the anode 104 while a second component configured to form a flexible structural network with the first component to provide flexibility to the anode 104 and adhesiveness toward a current collector (such as the copper foil 140 shown in FIG. 3C). In other embodiments, the anode 104 can also be constructed from other suitable active materials such as transition metal oxide, sulfur, selenium, selenium sulfide, graphite, silicon, silica, silicon/carbon, porous silicon, or porous silicon/carbon composites in addition to or in lieu of micro-sized silicon particles.

In certain embodiments, the first component of the composite binder 120 comprises a polymer having the following formula:

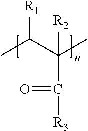

where each of R1, R2, and R3 includes hydrogen or —OX, wherein X is H, Li, Na, K, or a functional group having a formula of CₘH₂ₘ₊₁, m is an integer in the range from 1 to 10. In a particular example, the first composition can include PAA. In other embodiments, the first component can also include other materials to provide suitable target properties to the anode 104.

In some embodiments, the second component can include one or more amino acids with amide and hydroxyl groups to form self-crosslinking interactions with functional groups (e.g., carboxylic groups) of the first component via inter- and/or intra-chain gradient hydrogen bonds. In one example, the second component can include silk fibroin (SF). In other examples, the second component can also include one or more of spider silk protein, wool keratin, soy protein, or silk sericin. In further embodiments, the composite binder 120 can also include other suitable compositions in lieu of or in addition to the first or second component.

In certain embodiments, the first component can have a molecular weight in a range from about 2,000 up to about 300,000. Both the first and second components of the composite binder 120 can have a concentration range from about 5 wt % to about 40 wt % in the solvent and a weight percentage in a range from about 1 wt % to about 20 wt %. The mass ratio of the first component to the second component can be in the range from 1 to 0.01. In other embodiments, the molecular weight of the first or second component and the relative concentration or mass ratio of the first and second component can have other suitable values based on identity of the first or second component as well as particular application of the composite binder 120.

In the following description, an example composite binder 120 using PAA as the first component and using SF as the second component is used to illustrate aspects of the disclosed technology. As discussed in more detail herein, the PAA can form a network that provides structural integrity to the anode 104 while the SF can crosslink with one or more molecular chains of the PAA via gradient hydrogen bonds to form a flexible structural network 130 (shown in FIG. 3B) holding the micro-sized silicon particles 112. As such, the structural network 130 can accommodate large volume changes by stretching or contracting in the anode 104 during charge/discharge cycling, as discussed in more detail below with reference to FIGS. 2-14F.

As such, several embodiments of the lithium-ion battery 100 can have a higher charging capacity than conventional batteries using a carbon-based material for the anode 104. For example, as discussed above, a conventional lithium-ion battery with a carbon-based anode can have a charging capacity of about 372 mAh g⁻¹ while several embodiments of the lithium-ion battery 100 can have a charging capacity of about 2,000 mAh g⁻¹. As a result, the charging capacity of the lithium-ion battery 100 may be improved when compared to conventional lithium-ion batteries.

Several embodiments of the anode 104 of the lithium-ion battery 100 can also have improved charging/discharging cyclability. It is believed that the anode 104 can accommodate the large volume changes associated with lithiation/delithiation because the structural network 130 formed by the first and second components of the composite binder 120 is flexible and thus can contract and expand during lithiation/delithiation. For example, the structural network 130 may contract during lithium insertion and expand during lithium extraction without causing pulverization and/or other structural damage to the anode 104 as a whole. As such, the cyclability of the lithium-ion battery 100 can be improved to render the anode 104 stable for practical battery systems.

FIG. 2 shows example chemical interactions between the first component 132 (e.g., PAA) and the second component 134 (e.g., SF) of the self-crosslinking composite binder 120 in the silicon-based anode 104 of FIGS. 1A and 1B formed in accordance with embodiments of the disclosed technology. As shown in FIG. 2, PAA can include multiple polymer chains having carboxylic function groups. The polypeptide chains of SF are composed of primary amino acids, including glycine (Gly), serine (Ser), and alanine (Ala). These amino acids provide abundant polar groups such as amide (—NH), hydroxyl (—OH), and carboxyl (—C═O) that can crosslink with carboxylic groups of PAA to form inter-chain hydrogen bonds 121 as well as intra-chain hydrogen bonds 123. The chemical interactions between PAA and SF shown in FIG. 2 effectively form the structural network 130 that can bound micro-sized silicon particles 142 together to achieve sufficient structural integrity while maintaining suitable flexibility to accommodate volume changes during lithiation, as discussed in more detail below with reference to FIGS. 3A-3D.

FIGS. 3A-3D are example schematic diagrams showing micro-sized silicon particles 142 with —OH groups, hydrogen bonds 121 between molecular chains of PAA and SF, a lithiation/delithiation cycling process of PAA-based silicon-based electrode, and a lithiation/delithiation cycling process of PAA/SF silicon-based electrode, respectively, in accordance with embodiments of the disclosed technology. As shown in FIG. 3A, in certain embodiments, each micro-sized silicon particle 142 can include a silicon core 142a and a surface carbon layer 142b with abundant hydroxyl groups 144 on its surface. In certain examples, the surface carbon layer 142b covers only a portion of the surface of the silicon core 142a. In other examples, the surface carbon layer 142b covers essentially the entire surface of the silicon core 142a. In other embodiments, each micro-sized silicon particle 112 can include a silicon core 142a with other suitable surface layers (not shown) in addition to or in lieu of the surface carbon layer 142b.

As shown in FIG. 3B, multiple molecular chains of the first component 132 (e.g., PAA) can be crosslinked by multiple polypeptide chains of the second component 134 (e.g., SF) via multiple gradient hydrogen bonds 121 to form the structural network 130. In the illustrated example, the structural network 130 has a mesh configuration. In other examples, the structural network 130 can have star, bus, ring, tree, collapsed core, or other suitable configurations. Besides the crosslinking interactions between PAA and SF, both the first and second components 132 and 134 (e.g., PAA and SF, respectively) can have good chemical interactions with the micro-sized silicon particles 142 (FIG. 3A) via hydrogen bonds between hydroxyl and carboxyl or amide groups, and thus leading to robust bonding networks inside PAA/SF silicon-based electrodes.

FIGS. 3C and 3D illustrate lithiation and delithiation processes of an anode 104 formed using only PAA as a binder and using a composite binder of PAA/SF configured in accordance with embodiments of the disclosed technology, respectively. As shown in FIG. 3C, the anode 104 can include multiple micro-sized silicon particles 112 bound by and attached to a current collector (e.g., a copper foil 140) via PAA 132 and multiple conductive carbon particles 138. During Lithiation, lithium ions 112 (shown in FIG. 1A) are inserted into the silicon particles 142. Subsequently, during delithiation, lithium ions 112 (shown in FIG. 1B) are extracted from the silicon particles 142. During such cycling, the silicon particles 112 suffer large volume changes that can lead to severe cracks in the anode 104 and detachment of the silicon particles 142 from the copper foil 140. This detachment further results in poor electron transfer and thus capacity decay of the lithium-ion battery 100 in FIGS. 1A and 1B. In contrast, as shown in FIG. 3D, the structural network 130 formed by PAA and SF can stretch and contract during lithiation and delithiation, and thus accommodate the large volume changes during cycling. As such, risks of detachment of the silicon particles 142 from the copper foil 140 can be reduced if not avoided.

### Experiments

Certain experiments were conducted to study the effects of using a composite binder described herein on electromechanical performance of anodes in a lithium-ion battery. In the experiments, PAA/SF composite binders with different concentration or mass ratios were used for illustration purposes. The results of the experiments are presented below in conjunction with FIGS. 4A-14F.

PAA-only binder film was prepared by contacting a PAA aqueous solution (25 wt %) on the surface of a copper foil, and then dried at 155° C. for 2 hours under vacuum. The dried binder film was then peeled off the copper foil. For PAA/SF composite films, PAA/SF solutions were first prepared by mixing various mass ratios of PAA to SF (5 wt %, average Mw=100 kDa) ranging from 4:1 to 1:2 and then following the same procedures as synthesis of the PAA film. The PAA, PAA/SF, and SF binder films were immersed in electrolyte for 24 hours to study the solubility of the various binders.

### Synthesis of Super C45 Electrode

Conductive carbon (Super C45) nanoparticles were mixed with a binder in a mass ratio of 1:1 with DI water. The obtained slurry was then coated on a copper foil and dried at 155° C. for 2 hours under vacuum. The mass loading of Super C45 electrode was ˜0.5 mg cm⁻².

### Synthesis of Silicon-Based Electrode

Micro-sized Si/C particles were synthesized. Si/C particles were mixed with Super C45 and binder in a mass ratio of 6:2:2. DI water was used to adjust the viscosity of the slurry. The obtained Si/C electrode slurry was then coated on a copper foil before drying at 155° C. for 2 hours under vacuum. To study the effect of drying temperature on electrochemical performance of the silicon-based electrode, PAA/SF-based Si/C electrode was prepared using the same method but dried at 115° C. The prepared Si/C electrode was punched into round disks with a diameter of 12 mm. PAA/carboxymethylcellulose sodium salt (CMC) in a mass ratio of 1:1 was used as a reference binder for the Si/C electrode. The mass loading of Si/C in all electrodes was ˜1.0±0.2 mg cm⁻². PAA/SF-based Si/C electrode with a high mass ratio of 90:1:9 (active material:carbon additive:binder) was prepared using the same procedure. The mass loading of this PAA/SF-based Si/C electrode was ˜1.5 mg cm⁻².

### Materials Characterization

Fourier-transform infrared (FTIR) spectroscopy was performed by a FT-IR spectrometer in the attenuated total reflectance (ATR) mode. The scan range was 600-4,000 cm⁻¹ with a resolution of 4 cm⁻¹. The spectra of each sample were collected after 64 scans. The binder films were prepared by dropping binder solutions on a glass slide and dried 155° C. for 2 hours under vacuum. An empty glass slide was used as background during FTIR measurements. To investigate the interaction between Si/C and the binder, Si/C particles were mixed with PAA or SF and then dried at 155° C. under vacuum for 2 hours before FTIR test.

Differential scanning calorimetry (DSC) analysis was performed under nitrogen atmosphere. The binder film samples were heated from 20° C. to 250° C. and then cooled down to −90° C. for three cycles at a heating/cooling rate of 10° C. min⁻¹. The second heating cycle was used to plot DSC traces. X-ray diffraction (XRD) measurement of Si/C particles was performed. Thermogravimetric analysis (TGA) was conducted to determine the content of carbon in the Si/C particles. The temperature range was from room temperature to 750° C. with a heating rate of 10° C. min⁻¹. FTIR analysis of Si/C particles was performed. Scanning electron microscopy (SEM) images were obtained. 180-degree peeling test of electrodes was performed on a universal testing machine equipped with a 100-Newton load cell. The electrode materials were peeled off from a copper foil with a displacement rate of 60 mm min⁻¹. Each sample was repeated three times.

### X-Ray Photoelectron Spectroscopy (XPS) Analysis

The cycled Si/C electrodes were rinsed with dimethyl carbonate and dried overnight before XPS measurements. X-ray spot size for the acquisitions was on the order of 700×300 μm. Pressure in the analytical chamber during spectral acquisition was less than 1×10⁻⁸ Torr. Pass energy for survey spectra (composition) was 80 eV. Pass energy for the high-resolution spectra was 20 eV. The take-off angle (the angle between the sample normal and the input axis of the energy analyzer) was 0° (0-degree take-off angle, ˜100 Å sampling depth). For the high-resolution spectra, a Shirley background was used, and all binding energies were referenced to the C Is C—C bonds at 284.8 eV.

### Battery Assembly

For half-cell configuration, coin cells were assembled with silicon/carbon (or Super C45) as a working electrode and lithium foil as the counter and reference electrode. A polypropylene membrane was used as a separator. For the full cell configuration, PAA/SF-based Si/C anode (Φ16 mm, mass loading: 0.27 mg cm⁻²) was paired with LiFePO₄ cathode (LFP, Φ12 mm, mass loading: 11.16 mg cm⁻², MTI Corp.). The capacity ratio of Si/C anode to LFP cathode was ˜1.05. The electrolyte was composed of 1.3 M lithium hexafluorophosphate (LiPF₆) in ethylene carbonate (EC)/diethylene carbonate (DEC) (3:7 by volume) with 10 wt % fluoroethylene carbonate (FEC). The amount of electrolyte used in each cell was 100 μL.

### Electrochemical Measurements

A galvanostatic lithiation and delithiation test was conducted in a voltage window of 0.01-1.2 V vs. Li/Li⁺ at 30° C. The initial cycle was tested at a current density of 0.1 A g⁻¹, and the following cycles were tested at various C-rates (1.0 C was calculated based on the initial lithiation capacity of each coin cell). Cyclic voltammetry (CV) measurements were performed from open circuit voltage to 0.01 V and from 0.01 V to 1.2 V vs. Li/Li⁺ at a scan rate of 0.1 mV s⁻¹ at 30° C. Electrochemical impedance spectroscopy (EIS) measurements were performed in a frequency range from 5 MHz to 10 mHz with an AC oscillation amplitude of 10 mV. The PAA/SF-based Si/C∥LFP full cell was tested in a voltage window of 2.0-4.0 V at 0.1 C (1.0 C=170 mA g⁻¹). All cells were aged at 50° C. for 2 hours and 30° C. for 22 hours before testing.

### DFT Calculations

The binding energy between PAA and amino acids of SF was calculated by density-functional theory (DFT). All molecular structures (PAA, Gly, Ser, and Ala) were saturated by methyl groups at two ends. The geometries of molecular structures were first optimized at the B3LYP/6-31+G(d,p) level of theory, followed by energy calculation at the B3LYP/6-311++G(2df,2p) level of theory, both with DFT-D3(BJ) dispersion correction. The binding energy (ΔE_{b}) of PAA towards amino acid was calculated using the following equation: ΔE_{b}=E_{A+B}−(E_{A}+E_{B}), where E_{A+B}, E_{A}, and E_{B} represent total energy of A-B complex, A component, B component, respectively. A and B can be PAA and amino acids of SF.

### Chemical Interactions Between PAA and SF

As shown in FIG. 2, chemical interactions between PAA and SF via intra-chain hydrogen bonds can form the structural network 130. Besides the crosslinking interactions between PAA and SF, both PAA and SF showed chemical interactions with silicon/carbon (Si/C) particles 142 (FIG. 3A) via hydrogen bonds between hydroxyl and carboxyl or amide groups, thus leading to a robust bonding network inside PAA/SF-based Si/C electrodes.

To investigate chemical interactions inside a PAA/SF composite binder, the binding energy of PAA towards SF was calculated using DFT. The binding energy of PAA towards PAA itself and towards amino acids of SF follows the decreasing order (kcal mol⁻¹): PAA-PAA (−19.63)>PAA-Ser (−19.04)>PAA-Gly (−16.46)>PAA-Ala (−14.28). PAA monomer shows a strong binding energy with another PAA monomer via hydrogen bonding between —C═O and —OH, leading to high rigidness of a binder containing pure PAA. However, PAA shows gradient binding energy towards amino acids of SF ranging from −14.28 to −19.04 kcal mol⁻¹, which is believed to be attributed to the hydrogen bonding between carboxyl (—COOH) and different amide (—NH) groups. Moreover, this gradient binding energies of PAA/SF are sufficiently strong and thus can effectively maintain good structural integrity of micro-sized silicon electrodes during cycling. In addition, the solubility test shows that PAA, PAA/SF, and SF binders are insoluble and exhibit good stability towards carbonate-based electrolyte, which is also beneficial in maintaining good structural integrity of silicon-based electrode during cycling.

To further study the chemical interactions between PAA and SF, PAA/SF composite binders were prepared with various mass ratios. Table 1 below shows specific example compositions of the composite binder 120 utilizing PAA and SF. For example, PAA/SF (1/1) was composed of 50 wt % of PAA and 50 wt % of SF.

TABLE 1

| Example | PAA/wt % | SF/wt % | Denoted as |
|---|---|---|---|
| Example 1 | 100 | 0 | PAA |
| Example 2 | 80 | 20 | PAA/SF (4/1) |
| Example 3 | 67 | 33 | PAA/SF (2/1) |
| Example 4 | 50 | 50 | PAA/SF (1/1) |
| Example 5 | 33 | 67 | PAA/SF (1/2) |
| Example 6 | 0 | 100 | SF |

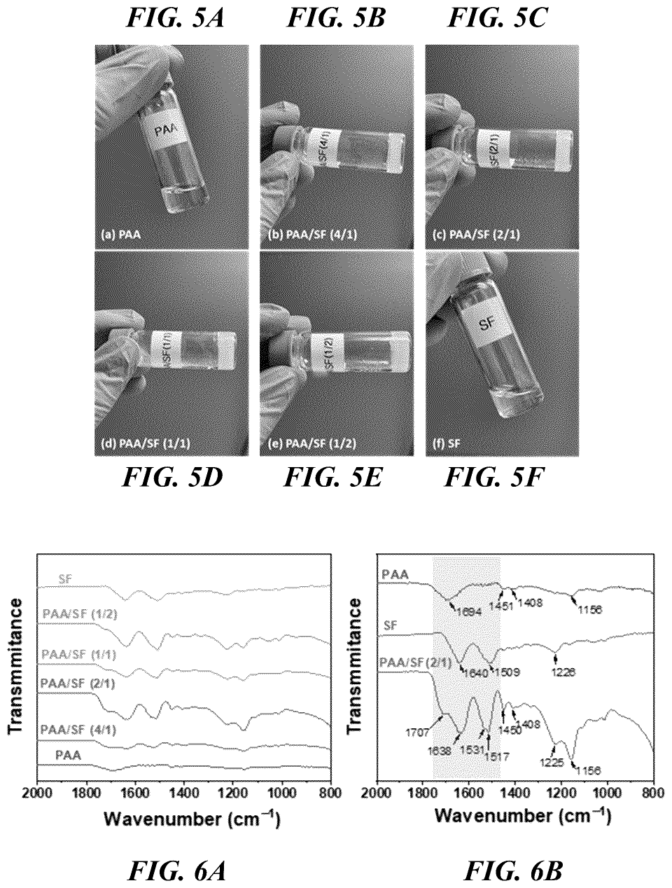

In this description, PAA/SF refers to the PAA/SF composite binder in a mass ratio of 2:1 unless otherwise stated. As shown in FIGS. 4A-5F, pure PAA and pure SF solutions are clear, whereas PAA/SF solutions are opaque and can become gelatinous after one week at room temperature, indicating strong chemical interactions between PAA and SF.

FTIR spectroscopy measurement of sample PAA/SF composite binders were performed. As shown in FIGS. 6A and 6B, PAA shows four peaks at 1692, 1451, 1408, and 1156 cm⁻¹, which are assigned as C═O stretching, —CH₂ asymmetric stretching, —COO⁻ in-plane bending, and C—O asymmetric stretching, respectively. SF binder shows three peaks at 1640, 1509, and 1226 cm⁻¹, which are assigned as C═O stretching (amide I), N—H in-plane bending (amide II), and C—N stretching (amide III), suggesting the random coil and/or α-helical confirmation of SF chains. For PAA/SF binders, the peak of C═O stretching in PAA shifts from 1692 to1707 cm⁻¹, while the peak of N—H in-plane bending in SF shifts from 1509 to 1517 and 1531 cm⁻¹, which is attributed to the formation of hydrogen bonding between —COOH and —NH groups.

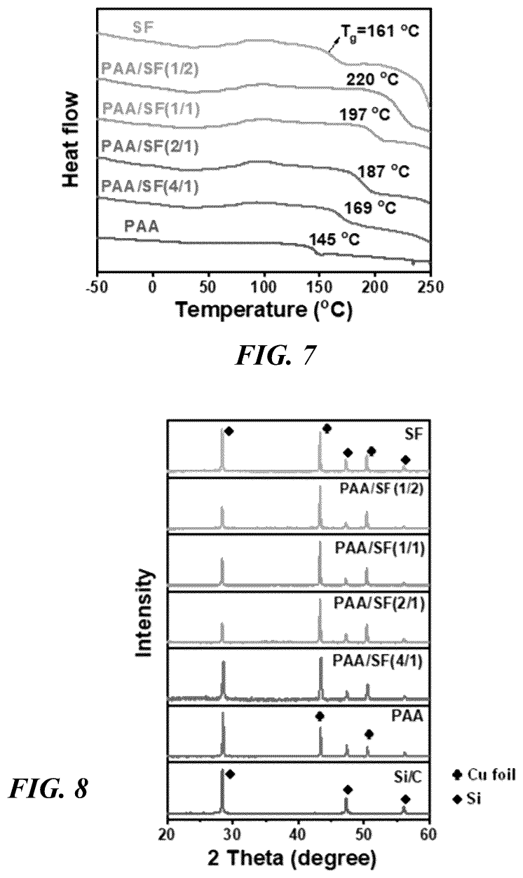

Additionally, the mass ratio of PAA to SF can also affect thermal properties of the PAA/SF composite binders. As shown in FIG. 7, PAA/SF composite binders showed a higher glass transition temperature (T_{g}) of 187° C. than that of PAA (145° C.) and SF (161° C.), suggesting the cross-linking interactions between PAA and SF chains. With further increase of SF, however, PAA/SF(1/1) and PAA/SF(1/2) binders show much increased T_{g} of 197° C. and 220° C., respectively, indicating the limited motion of PAA/SF chains. As a result, the rigidity of such PAA/SF composite binders may not effectively accommodate the large volume change of silicon electrodes during cycling. Therefore, the mass ratio of PAA to SF may be adjusted to derive a PAA/SF composite binder with suitable structural rigidity and flexibility for silicon-based anodes. FIG. 8 shows example XRD patterns of example silicon/carbon electrodes with different binders. In all example electrodes, three peaks located at 28°, 47°, and 57° (2 theta) are assigned to silicon. Two peaks located at 43° and 50° (2 theta) are assigned to copper foil.

### Adhesion Force and Electrochemical Stability of PAA/SF Composite Binder

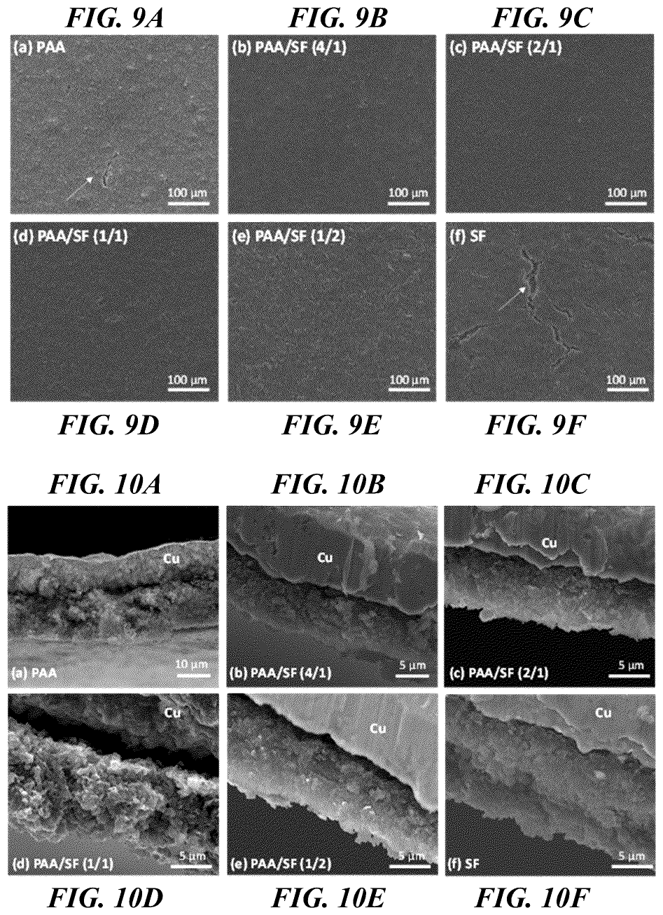

To investigate the adhesion force of various binders, micro-sized silicon/carbon (Si/C) electrodes with PAA and PAA/SF binders were prepared. Si/C microparticles were synthesized by the CO₂-thermic oxidation process. The Si/C particles show a particle size of 10-15 μm and 2.8 wt % of a carbon coating layer. FTIR analysis shows that Si/C particles contain hydroxyl groups on their surface, which can form hydrogen bonding with the carboxyl groups of PAA and amide groups of SF, as illustrated in FIG. 3A. The surface and cross-sectional morphologies of Si/C electrodes with various binders are shown in FIGS. 9A-10F. As shown in FIGS. 9A-10F, Si/C electrodes using PAA or SF binders showed some cracks, whereas Si/C electrodes using PAA/SF composite binders showed smooth surfaces and less cracks. For the cross-section observations, PAA-based electrodes showed some voids and cracks, whereas Si/C electrodes using SF or PAA/SF composite binders showed compact cross-sections. However, with the increase of SF, PAA/SF (1/1)- and PAA/SF (1/2)-based electrodes show gaps between the electrode materials and the copper foil.

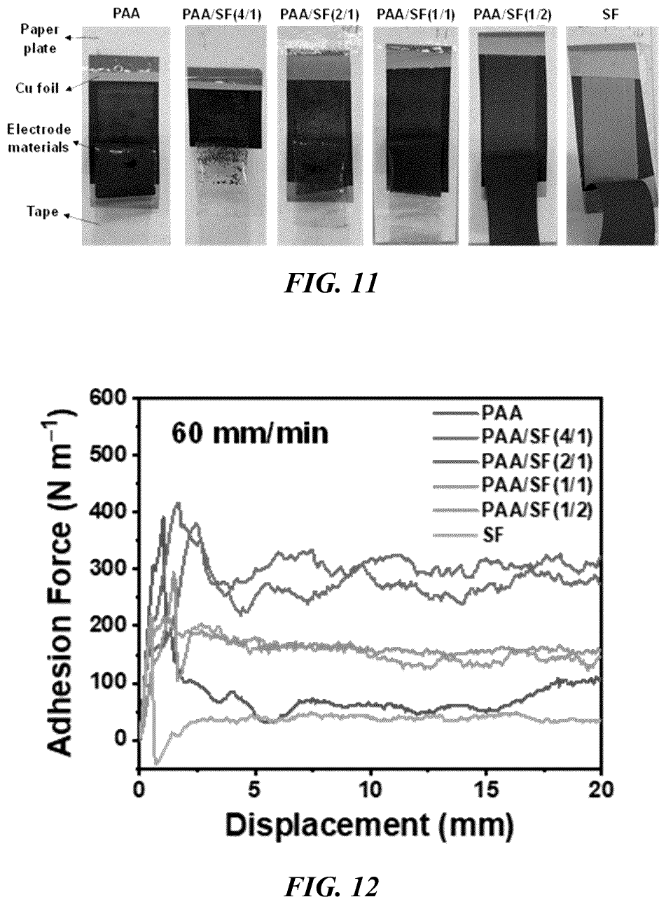

The adhesion force of PAA/SF composite binder was measured by 180-degree peeling test, as shown in FIGS. 11 and 12. PAA/SF-based Si/C electrodes showed an average adhesion force of 275 N m⁻¹ (˜5.23 N) towards a copper foil, which is much higher than that of Si/C electrodes with PAA (75 N m⁻¹), SF (50 N m⁻¹), and other reported binders. This high adhesion force of PAA/SF-based electrode towards a current collector is beneficial in maintaining structural integrity of electrodes during cycling. On the other hand, Si/C electrodes with PAA/SF(1/1) and PAA/SF(1/2) binders show decreased adhesion force (150 N m⁻¹) with the increase of SF, which corresponds well with the trend of glass transition temperature changes. Therefore, in certain embodiments, the mass ratio can be adjusted to achieve a target adhesive level of the Si/C electrode to the copper foil (or other suitable metal structure).

Besides the mass ratio of PAA to SF, the drying temperature of electrodes also affects the adhesion force and thus electrochemical performance of PAA/SF-based Si/C electrode. Therefore, in certain embodiments, the drying temperature can be adjusted to achieve a target adhesive level of the Si/C electrode to the copper foil (or other suitable metal structure). For the experiments discussed herein, all Si/C electrodes were dried at 155° C. unless otherwise stated in the following section.

To evaluate the electrochemical stability of PAA/SF composite binders, cyclic voltammetry (CV) measurements of conductive carbon (i.e., Super C45) electrodes were performed with PAA and PAA/SF at a scan rate of 0.1 mV s⁻¹. PAA-based Super C45 electrode showed gradually increased current density of redox peaks during ten cycles in the voltage range of 0.01-1.2 V vs. Li/Li⁺, whereas the PAA/SF-based one showed no redox peaks for ten cycles. Additionally, PAA/SF-based Super C45 electrode showed much lower specific capacity (<100 mAh g⁻¹) than that of PAA-based one (250 mAh g⁻¹) at the current density of 40 mA g⁻¹. The results showed that PAA/SF composite binders have good electrochemical stability.

Structural Characterization of Si/C Electrodes with PAA and PAA/SF Binder

Binders can provide structural integrity of micro-sized silicon electrodes during repeated (de)lithiation cycling. During the initial cycle at a current density of 0.1 A g⁻¹, PAA/SF-based Si/C electrode delivered a lithiation capacity of 3,415 mAh g⁻¹ with an initial Coulombic efficiency (ICE) of 85%, which is comparable to those of PAA-based one (3,466 mAh g⁻¹ and 86%). However, the cycled PAA-based Si/C electrode showed several cracks on the surface and big gaps between electrode materials and the copper foil. This observation is caused by the rigidness and weak adhesion force of the PAA. In contrast, PAA/SF-based electrode showed a compact surface and cross-section after the first cycle, indicating strong adhesive binding of the PAA/SF composite binder.

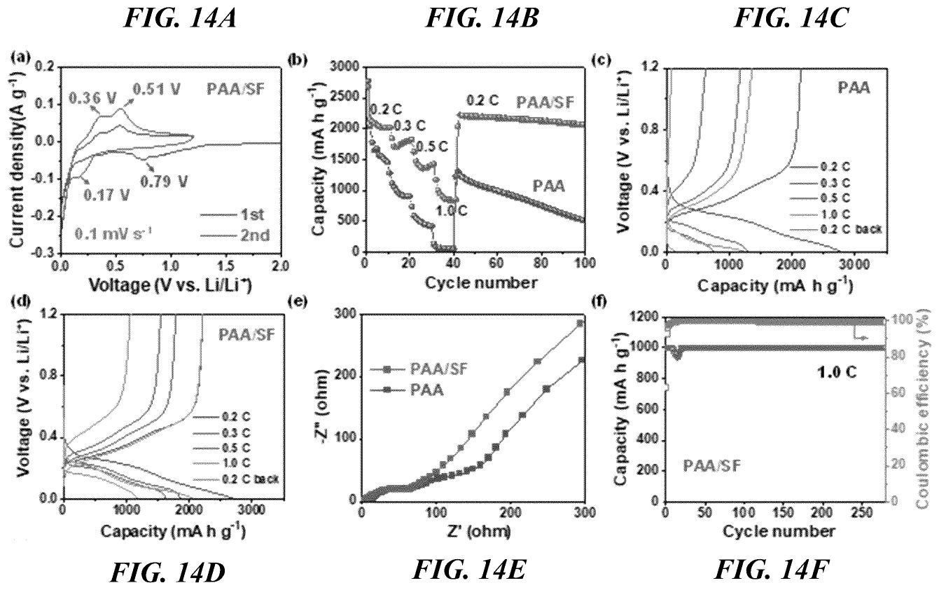

FIGS. 14A-14F show the long cycling performance of example Si/C electrodes with PAA and PAA/SF binder at 0.5 C in accordance with embodiments of the disclosed technology. In the first 100 cycles, the PAA-based electrode showed a higher capacity than that of PAA/SF-based electrode. This observation can be attributed to the fact that larger cracking and detachment were found in PAA-based Si/C electrode after the initial (de)lithiation cycle. As a result, fresh Si/C can be exposed to electrolyte during the initial cycling at 0.5 C, leading to a higher capacity than that of PAA/SF-based electrode in the first 100 cycles. However, this PAA-based electrode showed fast capacity decay after 100 cycles and delivers a low specific capacity of 198 mAh g⁻¹ after 500 cycles with an average CE of 99.3%.

On the other hand, example Si/C electrodes with PAA/SF composite binders delivered a specific capacity of 776 mAh g⁻¹ with an average CE of 99.6% after 500 cycles, which is higher than those of PAA-based electrode. Moreover, PAA/SF-based electrodes showed reversible voltage curves with a smaller overpotential when compared with PAA-based one. The morphologies of cycled Si/C electrodes with PAA and PAA/SF binders were further examined. After 500 cycles, PAA-based electrode showed wrinkles and large cracks through the electrode because of the poor adhesion force of PAA, leading to fast capacity decay during long cycling. However, the PAA/SF-based electrode still maintained an intact surface and cross section after 500 cycles, suggesting good structural integrity of electrode because of the strong adhesion force of the PAA/SF binder.

To further demonstrate the effect of binder on electrochemical property of Si/C electrodes, the cycling performance of example Si/C electrodes fabricated with other binders including PAA/SF(1/1), PAA/SF(1/2), and PAA/CMC were measured. Example Si/C electrodes with PAA/SF(1/1) and PAA/SF(1/2) binder showed an initial CE of 79.7% and 70.4% at 0.1 A g⁻¹, respectively. When tested at 0.5 C, PAA/SF(1/1)-based electrode exhibited a specific capacity of 1,200 mAh g⁻¹ after 100 cycles at 0.5 C but showed gradual capacity decay in the following cycles. Moreover, the PAA/SF(1/2)-based electrode showed very fast capacity decay even after the first cycle at 0.5 C, which can be attributed to the reduced binding ability of PAA/SF with the increase of SF. Also, the Si/C electrode with PAA/CMC binder achieved an initial CE of 86.8% at 0.1 A g⁻¹ but showed gradual capacity decay with a low specific capacity (<500 mAh g⁻¹) at 0.5 C after 500 cycles compared with PAA/SF-based one.

Electrochemical Performance of Si/C Electrodes with PAA and PAA/SF Binder

In addition to structural integrity of example Si/C electrodes, electrochemical performances of the example Si/C electrodes with PAA and PAA/SF binder were evaluated. During the first lithiation process, PAA/SF-based Si/C electrode showed a cathodic peak at 0.79 V vs. Li/Li⁺, as shown in FIG. 14A. For the following ten cycles, PAA/SF-based electrode exhibits one cathodic peak at 0.17 V and two anodic peaks at 0.36 and 0.51 V, indicating good reversibility of (de)lithiation processes of silicon anode. Moreover, this PAA/SF-based Si/C electrode shows much higher current density than that of PAA-based one, which suggests improved redox kinetics during cycling because of the good adhesion force of PAA/SF binder.

FIGS. 14B-14D show the rate performance of example Si/C electrodes with PAA and PAA/SF binder at 0.2 C, 0.3 C, 0.5 C, 1.0 C, and back to 0.2 C, respectively. The PAA/SF-based electrode exhibited much enhanced rate capability when compared with PAA-based one, especially at a high rate (specific capacity of 1,000 mAh g⁻¹ at 1.0 C), which is attributed to high adhesion force of PAA/SF binder that can maintain integrity of electrode during fast (de)lithiation processes. Also, the example PAA/SF-based electrode delivered a specific capacity >2,000 mAh g⁻¹ after 100 cycles when the C-rate was back to 0.2 C, whereas the PAA-based one exhibited a low capacity of 500 mAh g⁻¹. Moreover, the example PAA/SF-based Si/C electrode showed smaller bulk and interfacial resistances than those of PAA-based one after rate capability test, as shown in FIG. 14E, indicating the ability of maintaining good electron transfer and ion transport inside electrode because of the strong adhesion force of PAA/SF binder. As a result, PAA/SF-based Si/C electrode exhibited long cycle life (275 cycles at 1.0 C) at a constant discharge capacity of 1,000 mAh g⁻¹ (FIG. 14F). Moreover, this PAA/SF-based Si/C anode was paired with a commercial LFP cathode (mass loading of 11.16 mg cm⁻²) to assemble a full cell. The PAA/SF-based Si/C∥LFP full cell delivered a specific capacity of 113 mAh g⁻¹ at 0.1 C, indicating good utilization of PAA/SF-based Si/C.

From the foregoing, it will be appreciated that specific embodiments of the technology have been described herein for purposes of illustration, but that various modifications may be made without deviating from the disclosure. In addition, many of the elements of one embodiment may be combined with other embodiments in addition to or in lieu of the elements of the other embodiments. Accordingly, the disclosure is not limited except as by the appended claims.

I/We claim:

1. An electrochemical device, comprising:
a first electrode;
an electrolyte in electrical communication with the first electrode, the electrolyte containing a plurality of metal ions; and
a second electrode spaced apart from the first electrode and in electrical communication with the first electrode via the electrolyte, wherein the second electrode contains:
multiple micro-sized silicon (Si) particles bound together by a composite binder having a first component and a second component, the first component comprising multiple molecular chains individually with a composition having a formula of: 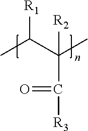
where each of R₁, R₂, and R₃ is hydrogen or —OX, wherein X is hydrogen (H), lithium (Li), sodium (Na), potassium (K), or a functional group having a chemical formula of CₘH₂ₘ₊₁, where m is an integer in the range from 1 to 10; and
the second component comprising multiple molecular chains individually having one or more of glycine, serine, alanine, tyrosine, valine, aspartic acid, glutamic acid, threonine, phenylalanine, isoleucine, leucine, arginine, lysine, methionine, or cysteine; and
wherein the molecular chains of the second component crosslinking the molecular chains of the first component to form a mesh-like structural network around at least some of the micro-sized silicon (Si) particles.

2. The electrochemical device of claim 1 wherein the multiple molecular chains of the second component individually include multiple amide and hydroxyl functional groups forming multiple hydrogen bonds with carboxylic functional groups on the multiple molecular chains of the first component.

3. The electrochemical device of claim 1 wherein the multiple molecular chains of the second component individually include multiple amide and hydroxyl functional groups forming multiple hydrogen bonds with carboxylic functional groups on the multiple molecular chains of the first component, and wherein the multiple hydrogen bonds crosslink the molecular chains of the first and second components to form the structural network that is stretchable and contractable during insertion and extraction of the metal ions, respectively.

4. The electrochemical device of claim 1 wherein the multiple molecular chains of the second component individually include multiple amide and hydroxyl functional groups forming multiple hydrogen bonds with carboxylic functional groups on the multiple molecular chains of the first component, and wherein the multiple hydrogen bonds have different bond energy levels.

5. The electrochemical device of claim 1 wherein the multiple molecular chains of the second component individually include multiple amino acids with amide and hydroxyl functional groups forming multiple hydrogen bonds with carboxylic functional groups on the multiple molecular chains of the first component, and wherein the multiple hydrogen bonds have different bond energy levels.

6. The electrochemical device of claim 1 wherein the second component includes one or more of silk fibroin, spider silk protein, wool keratin, soy protein, or silk sericin.

7. The electrochemical device of claim 1 wherein the first component includes poly(acrylic acid) (PAA) and the second component includes one or more of silk fibroin, spider silk protein, wool keratin, soy protein, or silk sericin.

8. The electrochemical device of claim 1 wherein the first component includes poly(acrylic acid) (PAA) and the second component includes silk fibroin, and wherein multiple molecular chains of the silk fibroin individually include multiple amino acids with amide and hydroxyl functional groups forming multiple hydrogen bonds with carboxylic functional groups on multiple molecular chains of the PAA in the first component, and wherein the multiple hydrogen bonds have different bond energy levels.

9. A method of forming an electrode, comprising:
mixing a first component and a second component with micro-sized silicon/carbon (Si/C) particles in a solvent to derive a slurry, the first component having multiple molecular chains individually having a formula of: 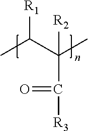
where each of R₁, R₂, and R₃ is hydrogen or —OX, wherein X is hydrogen (H), lithium (Li), sodium (Na), potassium (K), or a functional group having a chemical formula of CₘH₂ₘ₊₁, where m is an integer in the range from 1 to 10 while the second component comprising multiple molecular chains individually having one or more of glycine, serine, alanine, tyrosine, valine, aspartic acid, glutamic acid, threonine, phenylalanine, isoleucine, leucine, arginine, lysine, methionine, or cysteine;
coating a metal foil with the derived slurry; and
drying the metal foil coated with the derived slurry under vacuum, thereby crosslinking the molecular chains of the first component with the molecular chains of the second component to form a mesh-like structural network around at least some of the micro-sized silicon (Si) particles.

10. The method of claim 9 wherein:
mixing the first component and the second component includes mixing the first component and the second component at a mass ratio between the first component and the second component, thereby forming multiple hydrogen bonds between multiple amide and hydroxyl functional groups of the second component with carboxylic functional groups of the first component, the multiple hydrogen bonds crosslink the molecular chains of the first and second components to form the mesh-like structural network around the multiple silicon/carbon (SiC) particles; and
wherein the method further includes adjusting the mass ratio between the first and second components based on a target level of rigidity of the mesh-like structural network.

11. The method of claim 9 wherein:
mixing the first component and the second component includes mixing the first component containing poly(acrylic acid) (PAA) and the second component containing silk fibroin at a mass ratio between the first component and the second component, thereby forming multiple hydrogen bonds between multiple amide and hydroxyl functional groups of the silk fibroin with carboxylic functional groups of the PAA, the multiple hydrogen bonds crosslink the molecular chains of the PAA and the silk fibroin to form mesh-like structural network around the multiple silicon/carbon (SiC) particles; and
wherein the method further includes adjusting the mass ratio between the PAA and the silk fibroin based on a target level of rigidity of the mesh-like structural network.

12. The method of claim 9 wherein drying the metal foil coated with the derived slurry includes drying the metal foil coated with the derived slurry at a drying temperature, and wherein the method further includes adjusting the drying temperature to achieve a target level of adhesion between the Si/C particles to the metal foil.

13. The method of claim 9 wherein mixing the first component and the second component includes mixing the first component and the second component at a mass ratio between the first component and the second component, and wherein the method further includes adjusting the mass ratio between the first component and the second component based on a target level of adhesion between the Si/C particles to the metal foil.

14. The method of claim 9 wherein mixing the first component and the second component includes mixing the first component and the second component at a mass ratio between the first component and the second component, and wherein the method further includes increasing the mass ratio between the first component and the second component to increase adhesion between the Si/C particles to the metal foil.

15. The method of claim 9 wherein mixing the first component and the second component includes mixing the first component and the second component at a mass ratio between the first component and the second component, and wherein the method further includes decreasing the mass ratio between the first component and the second component to decrease adhesion between the Si/C particles to the metal foil.

16. A composite binder for binding multiple silicon particles together to form one or more electrodes, the composite binder comprising:
a first component comprising a composition having a formula of: 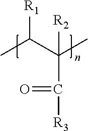
where each of R₁, R₂, and R₃ is hydrogen or —OX, wherein X is hydrogen (H), lithium (Li), sodium (Na), potassium (K), or a functional group having a chemical formula of CₘH₂ₘ₊₁, where m is an integer in the range from 1 to 10;
a second component having one or more of glycine, serine, alanine, tyrosine, valine, aspartic acid, glutamic acid, threonine, phenylalanine, isoleucine, leucine, arginine, lysine, methionine, or cysteine; and
a solvent containing both the first and second components.

17. The composite binder of claim 16 wherein the first component comprises a molecular weight in a range from about 2,000 to about 300,000.

18. The composite binder of claim 16 wherein a concentration of the first or second component in the solvent is about 5 wt % to about 40 wt %.

19. The composite binder of claim 16 wherein a mass ratio of the first component to the second component is in a range from 1 to 0.01.

20. The composite binder of claim 16 wherein a weight percentage of the first or second component is from about 1 wt % to about 20 wt %.
